(19) United States
(12) Patent Application Publication
(10) Pub. No.: US 2022/0029233 A1
(43) Pub. Date: Jan. 27, 2022

(54) ELECTROCHEMICAL ENERGY STORAGE CELL

(71) Applicant: CARL FREUDENBERG KG, Weinheim (DE)

(72) Inventors: Peter KRITZER, Forst (DE); Marina NUSSKO, Mannheim (DE); Jens HOFMANN, Darmstadt (DE); Ernst OSEN, Birkenau (DE); Volker SCHROIFF, Hemsbach (DE); Ugo ANSALDI, Piossasco (IT); Claus JÖST, Weinheim (DE); Thorsten HILLESHEIM, Bad Honnef (DE)

(21) Appl. No.: 17/297,084

(22) PCT Filed: Nov. 26, 2019
(86) PCT No.: PCT/EP2019/082599

§ 371 Date: May 26, 2021

(51) Int. Cl. H01M 50/188; H01M 50/148; H01M 50/152; H01M 50/169; H01M 50/193; H01M 50/195

(52) U.S. Cl. CPC H01M 50/188; H01M 50/154; H01M 50/195; H01M 50/169; H01M 50/193; H01M 50/152

(57) ABSTRACT

An electrochemical energy storage cell comprising a cell winding received in a casing, wherein the casing is closed at least on one end face by a cover, wherein the cover has a fixing portion for fixing the cover on the casing and a pole portion for contacting a conductor of the cell winding, wherein the fixing portion and the pole portion are connected to one another via a compensating element, wherein the compensating element is formed to be elastic and electrically insulating.

The invention relates to an electrochemical energy storage cell comprising a cell winding which is received in a casing, wherein the casing is closed at least on one end face by a cover, wherein the cover has a fixing portion for fixing the cover on the casing and a pole portion for contacting a conductor of the cell winding.

An energy storage cell of this type is known, for example, from DE 10 2008 025 884 A1 and is used in many different ways in technology. Such an energy storage cell is often circular when viewed from above and is therefore also known as a round cell. Round cells are used, for example, to power battery-operated hand tools. However, it is also known to combine a plurality of round cells into a single unit, which in turn is suitable for providing energy for an electric vehicle.

In the presently known round cells, the pole portion of the cover is received in a ring-shaped plastic element on the outer circumferential side, and the casing is shaped in the region of the ring-shaped element such that the pole portion of the cover and the ring-shaped element are at least partially enclosed by the casing. The ring-shaped element forms an electrical insulation of the pole portion in relation to the casing. This is particularly important when the pole portion receives a conductor of the cell winding and forms an electrode, and the energy storage cell casing receives the second conductor and forms the other electrode. With this design, a defective electrically conductive contact between the pole portion and the casing must be avoided at all costs. The deformation of the casing is mostly done by crimping. To prevent an impermissibly high pressure from developing inside the casing due to a malfunction, the cover is provided with a mechanism which causes a pressure equalisation in the direction of the environment in the event of impermissibly high pressure. Furthermore, when a defined internal overpressure is exceeded, the cover deforms to such an extent that the electrical contact between the cell winding and the pole portion is interrupted.

Due to the necessary deformation of the casing during the crimping process to fix the cover, the complete structural height of the casing is not available for the cell winding; a sufficiently high dead space must be available for the accommodation of the cover and for the deformation. Furthermore, the problem arises that the ring-shaped element, which forms an insulator, can be damaged by the forming process, which results in a failure of the energy storage cell.

The object of the invention is to provide an energy storage cell which has a compact design and in which reliable electrical insulation of the pole portion with respect to the casing is provided.

This object is solved using the features of claim 1. The dependent claims make reference to advantageous embodiments.

To solve the task, the fixing portion and the pole portion are connected to one another via a compensating element, wherein the compensating element is formed to be elastic and electrically insulating. Thereby, the fixing portion, the pole portion, and the compensating element form an integral part of the cover.

In the case of a round cell, the cover is round when viewed from above. The pole portion is located in the centre of the cover, surrounded by the compensating element. The fixing portion is located on the outer circumference of the cover. Since the pole portion and the fixing portion are connected to each other by the electrically insulating compensating element, the pole portion is electrically insulated from the casing at the same time. This eliminates the need for an additional element for electrical insulation between the cover and the casing. This was previously formed using a ring-shaped sealing element, which also acted as an insulation element. The compensating element is preferably made of plastic, for example an injection-mouldable plastics material. The fixing portion and the pole portion may be made of metallic material, wherein the pole portion consists of electrically conductive material.

The compensating element can be made of elastomeric material. This allows the compensating element to deform reversibly, which is particularly advantageous regarding pressure compensation between the inside of the casing and the environment.

According to an alternative embodiment, the compensating element may also be configured to provide some elasticity. In particular, the compensating element may be shaped such that the compensating element is elastically movable. For this purpose, circumferential beading can, for example, be inserted into the compensating element which allows the pole portion to move in the axial direction. It is also conceivable for the compensating element to be in the form of a bellows, at least in sections. The compensating element may also have sections formed in the shape of film hinges. The elastically formed areas can be inserted concentrically into the compensating element.

Due to the elastically yielding shaping, it is possible to form the compensating element from thermoplastic material. In addition to the use of thermoplastic elastomers, in particular inexpensive thermoplastic materials such as polyethylene (PE), polyethylene terephthalate (PET) or polypropylene (PP) can be used. Although these thermoplastic materials only have a comparatively low elasticity, the elastic shaping of the compensating element results in the overall elasticity and reversible mobility desired for the compensating element.

Alternatively, the compensating element may have an elastic shape as well as be formed of elastic material, for example an elastomer.

A predetermined breaking point may be incorporated in the compensating element. If the pressure inside the casing exceeds a permissible level due to faulty processes or material defects, the predetermined breaking point opens and thus enables controlled pressure compensation. According to an advantageous embodiment, the predetermined breaking point does not open until the compensating element has deformed such that the pole portion is spaced from the cell winding. This causes the conductor to detach from the pole portion so that the energy storage cell is de-energized when viewed from the outside. The predetermined breaking point is preferably designed in such a way that the compensating element opens irreversibly. This can prevent the damaged energy storage cell from continuing to operate.

The predetermined breaking point can be in the form of a groove. If the pressure inside the casing exceeds a predetermined level, the compensating element breaks open along the predetermined breaking point, thus enabling the excess pressure in the cell to be lowered in a targeted manner. The groove can be V-shaped and ring-shaped and extend from the side of the compensating element facing away from the casing into the interior.

The cover can be connected to the casing in a materially-bonded manner. In this regard, according to a first embodiment, the ring-shaped edge may rest on the ring-shaped edge of the casing. According to a second advantageous embodiment, the fixing portion comprises a cylindrical portion which surrounds the casing in the region of the opening circumferentially. The materially-bonded connection can be an adhesive connection or a welded connection. The advantage of the materially-bonded connection is in particular the low space requirement.

The cover can be fixed to the casing by means of electromagnetic pulse forming. During electromagnetic pulse forming, the cover and casing of the energy storage cell are exposed to pulsating magnetic fields, which cause the cover and casing to heat up along the surfaces in contact with each other and also to deform locally. The heating and local deformation result in a materially-bonded and tight connection between the cover and the casing. The advantage here is that only a small amount of deformation takes place, so that, in contrast to forming by means of crimping, it is not necessary to provide a separate space for the deformation. The joining of cover and casing can also be done along the abutting edges.

An insulation element can be arranged between the cell winding and the cover. The insulation element prevents components of the cell winding from coming into contact with the pole portion.

The insulation element may be formed from an elastomeric material. Thereby, the insulation element can be designed in such a way that it almost completely fills the space between the pole portion and the cell winding. This can effectively prevent contact between the cell winding and the pole portion.

The insulation element may be formed of a silicone material. Silicone materials react with the electrolyte which is present next to the cell winding in the casing, and which surrounds the cell winding. Due to the reaction of the silicone material with the electrolyte, the insulation element swells and increases its volume. This allows the space between the cell winding and the pole portion to be completely filled with the insulation element.

The insulation element can be equipped with thermally conductive particles. Until now, the problem was that it is difficult to transport heat from the inside of the cell winding. Since the insulation element is thermally conductive as a whole because of the thermally conductive particles, heat generated inside the casing, or inside the cell winding, can be dissipated to the outside. This can improve the cooling of the energy storage cell, which is accompanied by an increase in efficiency.

The cooling of the energy storage cell can be further improved, if a further insulation element is arranged between the bottom of the casing and the cell winding. In this embodiment, the cell winding is sandwiched between two thermally conductive insulation elements. The heat transport takes place between the cell winding, the two insulation elements and the jacket of the casing, or the cover and the bottom of the casing.

Some embodiments of the energy storage cell according to the invention are explained in more detail below with reference to the figures. These show, in each case schematically:

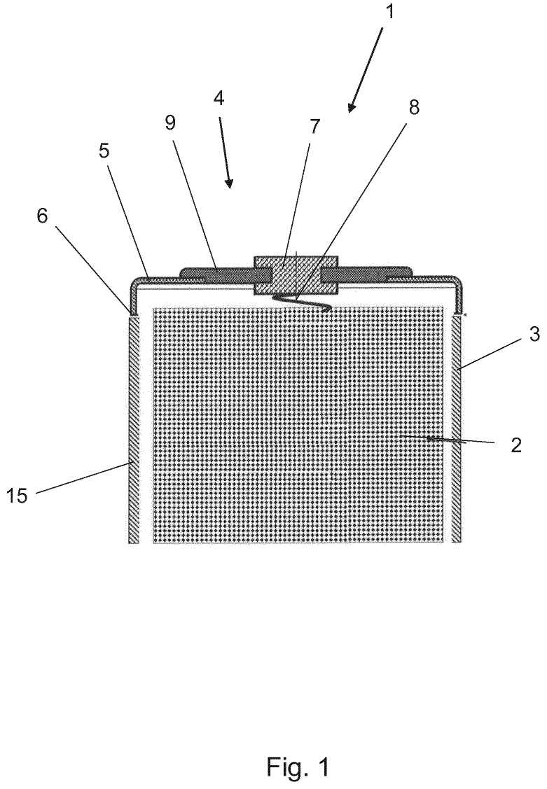

FIG. 1 a profile view of the upper portion of an energy storage cell;

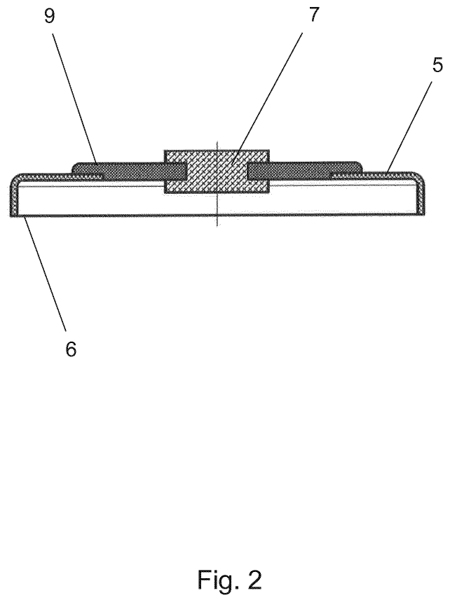

FIG. 2 the cover of an energy storage cell;

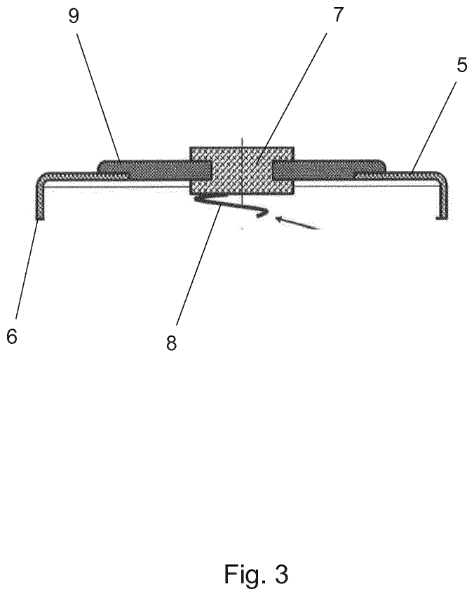

FIG. 3 the cover with conductor;

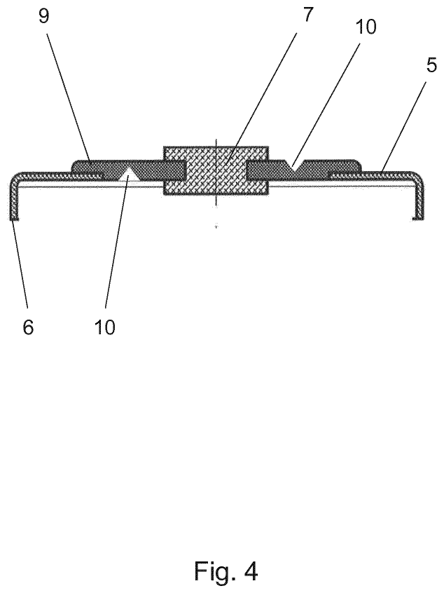

FIG. 4 the cover with predetermined breaking points;

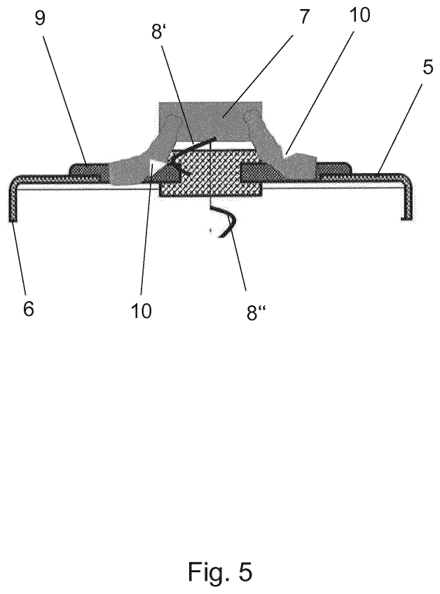

FIG. 5 the cover in the damaged state;

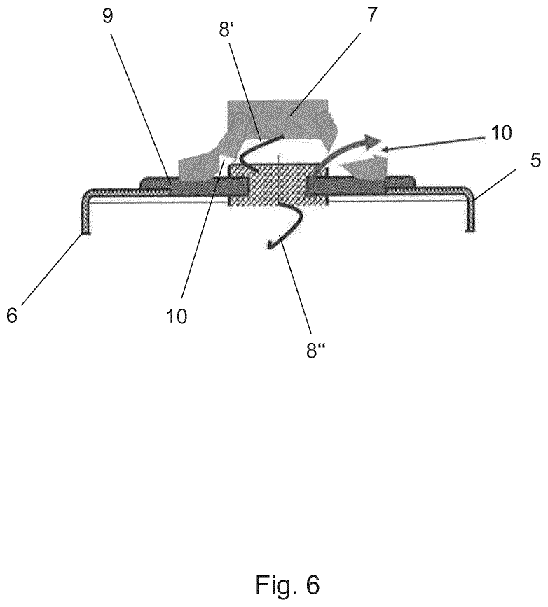

FIG. 6 the cover with the predetermined breaking point broken;

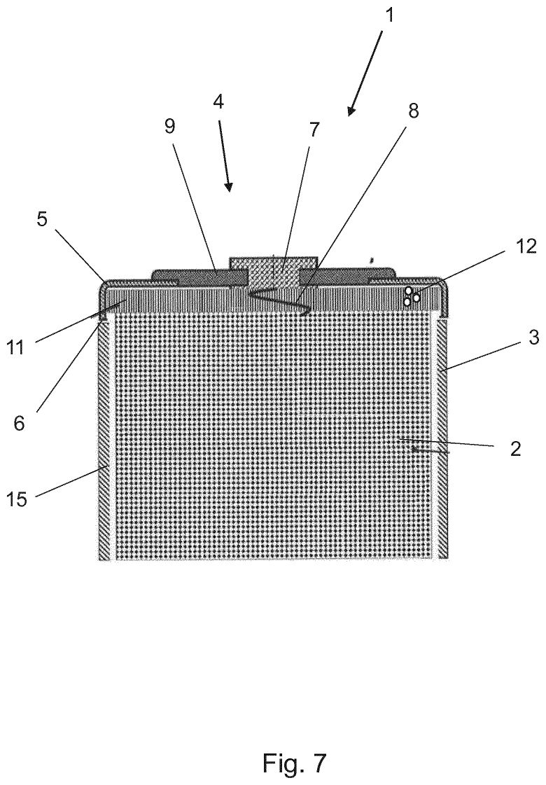

FIG. 7 an energy storage cell with an insulation element;

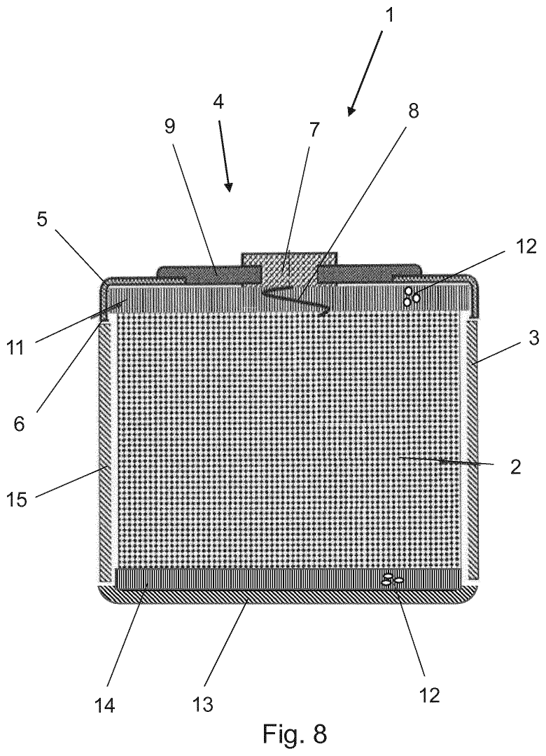

FIG. 8 an energy storage cell with an insulation element in the bottom and in the cover;

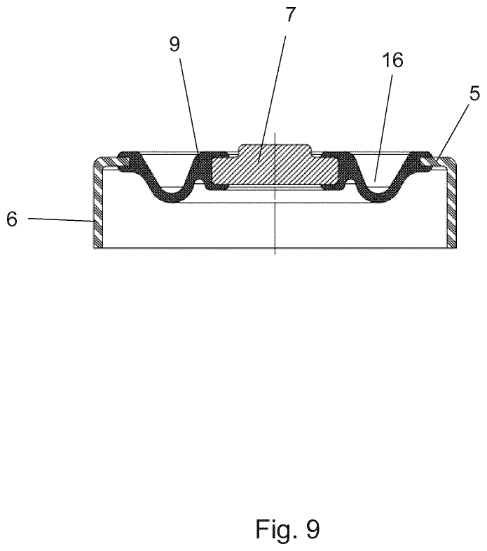

FIG. 9 a compensating element with elastic shaping.

The figures show an electrochemical energy storage cell 1 in the form of a round cell. The energy storage cell 1 comprises a cell winding 2 which is accommodated in a casing 3. If the energy storage cell 1 is in the form of a lithium-ion battery, the cell winding 2 comprises two conductors and two separators, wherein the conductors are separated from each other by the separators. An active material is applied to the conductors and the two conductors separated by the separators are wound into a round structure. The casing 3 is made of metallic material and is cylindrical in shape. On one end face, the casing 3 has a bottom 13 formed of the same material and integral with the cylindrical wall 15. On one end face 4, the casing 3 is closed by a cover 5.

The cover 5 has a fixing portion 6 for fixing the cover 5 to the casing 3. Furthermore, the cover 5 has a pole portion 7 for contacting a conductor 8 of the cell winding 2. The second conductor of the cell winding 2 is associated with the bottom 13 of the casing 3.

The fixing portion 6 and the pole portion 7 are connected to each other via a compensating element 9. The compensating element 9 is elastic and electrically insulating. In this case, the compensating element 9 is made of elastomeric material.

When viewed from above, the cover 5 is circular in shape. The pole portion 7 is centred and centrally located in the cover 5 and surrounded by the compensating element 9. The compensating element 9 is positively and materially connected to the pole portion 7. The fixing portion 6 has a disc-shaped portion in whose opening the compensating element 9 and the pole portion 7 are arranged. The compensating element 9 is fixed in a materially-bonded manner in the area of the edge of the opening of the fixing portion 6. The fixing portion 6 further comprises a cylindrical portion which rests on the edge of the end face side of casing 3. In the area of the two contacting edges, the cover 5 and the casing 3 are joined together by means of electromagnetic pulse forming in a materially-bonded manner.

FIG. 1 shows the upper portion of an electrochemical energy storage cell 1 in the form of a round cell. The conductor 8 is centrally connected in the cell winding 2 to an electrode of the cell winding 2. The compensating element 9 is disc-shaped and elastic because it is made of elastomeric material. This allows the pole portion 7 to move in the axial direction depending on the internal pressure of the casing 3. The compensating element 9 forms an electrical insulation between the pole portion 7 and the fixing portion 6. In this respect, the casing 3 together with the fixing portion 6 can form a second pole.

FIG. 2 shows the cover shown in FIG. 1 in detail.

FIG. 3 shows the cover shown in FIG. 1 in detail together with the conductor 8, which is electrically conductively attached to the pole portion 7.

FIG. 4 shows another embodiment of the cover shown in FIG. 1. In the present embodiment, the compensating element 9 is provided with a predetermined breaking point 10. FIG. 4 shows two different configurations of the predetermined breaking point 10. In the embodiment to the right of the line of symmetry, the predetermined breaking point 10 is introduced externally into the compensating element 9. In the embodiment to the left of the line of symmetry, the predetermined breaking point 10 is introduced on the side of the compensating element 9 facing the cell winding 2. In both embodiments, the predetermined breaking point 10 is in the form of a V-shaped groove which surrounds the pole portion 7 concentrically.

FIG. 5 shows the cover 5 shown in FIG. 4, with the pole portion 7 spaced axially from the cell winding 2 due to increased internal pressure inside the casing 3. In this case, the conductor 8 is torn into two portions 8′, 8″ so that the pole portion 7 is electrically insulated from the cell winding 7. In this respect, the energy storage cell 1 is de-energized in this embodiment. This can prevent further charging of the energy storage cell 1, which would be particularly harmful after the pressure increase inside the energy storage cell 1. In the embodiment shown in FIG. 5, only a deformation of the compensating element 9 has taken place. The predetermined breaking points 10 are still intact.

In the embodiment according to FIG. 6, the internal pressure inside the casing 3 has increased once again compared to the embodiment shown in FIG. 5. In this case, the permissible internal pressure has exceeded a predetermined level and the predetermined breaking point 10 has opened. This allows gas to escape from the interior of the casing 3, so that the pressure inside is reduced in a targeted and controlled manner. In this respect, by opening the predetermined breaking point 10, a targeted destruction of the energy storage cell 1 takes place and an explosive destruction of the energy storage cell 1 can be prevented.

FIG. 7 shows an energy storage cell 1 according to FIG. 1, wherein an insulation element 11 is arranged between the cell winding 2 and the cover 5. The insulation element 11 is made of elastomeric material, in this case a silicone material. The insulation element 11 is provided with thermally conductive particles 12. After assembly, the insulation element 11 comes into contact with the electrolyte of the cell winding 2, causing the insulation element 11 to swell. As a result, the insulation element 11 fills the space between the cell winding 2 and the cover 5. The thermally conductive particles are electrically non-conductive mineral particles. Advantageous thermally conductive particles 12 include aluminium oxide (Al₂O₃), aluminium oxide hydroxide (AlOOH), aluminium hydroxide (Al(OH)₃), magnesium hydroxide (Mg(OH)₂), or boron nitride (BN).

FIG. 8 shows a further development of the energy storage cell 1 shown in FIG. 7. In the present embodiment, a further insulation element 14 is arranged between the bottom 13 of the casing 3 and the cell winding 2. The further insulation element 14 is also provided with thermally conductive particles 12 and is made of a silicone material.

The following materials can be considered in particular as materials for the compensating element 9: ethylene propylene diene monomer (EPDM), methyl rubber (IIR), fluororubber (FPM), polyacrylate rubber (ACM), silicone rubber (VMQ) or fluorinated silicone rubber (F-VMQ).

In principle, however, it is also conceivable to form the compensating element 9 from a thermoplastic elastomer (TPE) or from a thermoplastic material such as polyethylene (PE) or polypropylene (PP). In this embodiment, the compensating element 9 preferably includes elastically movable sections such as beading, film hinges or the like.

Such a compensating element 9 with elastic shaping is shown in FIG. 9. In this embodiment, the elasticity and softness of the compensating element 9 is provided by a circumferential, concentrically arranged beading 16. As a result, the compensating element 9 is shaped in the manner of a bellows-shaped membrane so that the pole portion 7 can move in the axial direction.

What is claimed is:

1. An electrochemical energy storage cell, comprising a cell winding which is received in a casing, wherein the casing is closed at least on one end face by a cover, wherein the cover has a fixing portion for fixing the cover to the casing and a pole portion for contacting a conductor of the cell winding, wherein the fixing portion and the pole portion are connected to one another via a compensating element, wherein the compensating element is formed to be elastic and electrically insulating.

2. The energy storage cell according to claim 1, wherein the compensating element is made of elastomeric material.

3. The energy storage cell according to claim 1, wherein the compensating element is elastically movably shaped.

4. The energy storage cell according to claim 1, wherein a predetermined breaking point is introduced into the compensating element.

5. The energy storage cell according to claim 4, wherein the predetermined breaking point (10) is in the form of a groove.

6. The energy storage cell according to claim 1, wherein the cover is connected to the casing in a materially-bonded manner.

7. The energy storage cell according to claim 1, wherein the cover is fastened to the casing by means of electromagnetic pulse forming.

8. The energy storage cell according to claim 1, wherein an insulation element is arranged between the cell winding and the cover.

9. The energy storage cell according to claim 8, wherein the insulation element is formed of an elastomeric material.

10. The energy storage cell according to claim 8, wherein the insulation element is formed of a silicone material.

11. The energy storage cell according to claim 8, wherein the insulation element is equipped with thermally conductive particles.

12. The energy storage cell according to claim 8, wherein a further insulation element is arranged between the bottom of the casing and the cell winding.
